(19) United States
(12) Patent Application Publication
(10) Pub. No.: US 2026/0121740 A1
(43) Pub. Date: Apr. 30, 2026

(54) DYNAMIC REDUNDANCY WITH PARALLEL OPTICAL LINKS

(71) Applicant: Volantis Semiconductor, Inc., Portland, OR (US)

(72) Inventors: Tapabrata Ghosh, San Francisco, CA (US); Horst Wagner, Goleta, CA (US)

(73) Assignee: Volantis Semiconductor, Inc., Portland, OR (US)

(21) Appl. No.: 19/260,549

(22) Filed: Jul. 6, 2025

Related U.S. Application Data
(63) Continuation-in-part of application No. 19/260,471, filed on Jul. 5, 2025.
Application No. 19/260,471 is a continuation-in-part of application No. 19/243,462, filed on Jun. 19, 2025.
Application No. 19/243,462 is a continuation-in-part of application No. 19/235,870, filed on Jun. 12, 2025.
Application No. 19/235,870 is a continuation-in-part of application No. 19/230,233, filed on Jun. 6, 2025.
Application No. 19/230,233 is a continuation-in-part of application No. 19/223,614, filed on May 30, 2025.
Application No. 19/223,614 is a continuation-in-part of application No. 19/222,606, filed on May 29, 2025.
Application No. 19/222,606 is a continuation-in-part of application No. 19/211,446, filed on May 19, 2025.
Application No. 19/211,446 is a continuation-in-part of application No. 19/210,116, filed on May 16, 2025.
Application No. 19/210,116 is a continuation-in-part of application No. 19/192,587, filed on Apr. 29, 2025.
Application No. 19/192,587 is a continuation-in-part of application No. 19/192,146, filed on Apr. 28, 2025.
Application No. 19/192,146 is a continuation-in-part of application No. 19/189,471, filed on Apr. 25, 2025.
Application No. 19/189,471 is a continuation-in-part of application No. 19/188,057, filed on Apr. 24, 2025.
Application No. 19/188,057 is a continuation-in-part of application No. 19/177,834, filed on Apr. 14, 2025.
Application No. 19/177,834 is a continuation-in-part of application No. 19/093,546, filed on Mar. 28, 2025.
Application No. 19/093,546 is a continuation-in-part of application No. 19/079,851, filed on Mar. 14, 2025.
Application No. 19/079,851 is a continuation-in-part of application No. 19/056,456, filed on Feb. 18, 2025.
Application No. 19/056,456 is a continuation-in-part of application No. 19/023,647, filed on Jan. 16, 2025.
Application No. 19/023,647 is a continuation-in-part of application No. 18/978,188, filed on Dec. 12, 2024.
Application No. 18/978,188 is a continuation-in-part of application No. 18/958,107, filed on Nov. 25, 2024.
Application No. 18/958,107 is a continuation-in-part of application No. 18/940,944, filed on Nov. 8, 2024.
(60) Provisional application No. 63/714,353, filed on Oct. 31, 2024.
(60) Provisional application No. 63/720,216, filed on Nov. 14, 2024.
(60) Provisional application No. 63/750,817, filed on Jan. 29, 2025.
(60) Provisional application No. 63/750,822, filed on Jan. 29, 2025.

(51) Int. Cl. H04B 10/032

(52) U.S. Cl. CPC H04B 10/032

(57) ABSTRACT

A first circuit is coupled to a second circuit. The coupling is based on a first optical link. The first optical link includes a first optical source and a first optical medium. The first optical source can include a ring resonator, a vertical-cavity surface-emitting laser (VCSEL), etc. The optical medium can include a fiberoptic cable, a multicore fiber cable, a waveguide, and so on. The plurality of optical links includes a plurality of spare optical links. Data is sent by the first circuit to the second circuit. The sending is based on the first optical link. The optical links are tested, based on a round robin protocol. The testing includes determining a failure within the first optical link. The first optical link is replaced with a second optical link. The second optical link is within the spare optical links. The replacing is transparent to the sending.

### RELATED APPLICATIONS

This application is a continuation-in-part of U.S. patent application “Reduction Of Waveguide Crosstalk With Sub-Wavelength Structures” Ser. No. 19/260,471, filed Jul. 5, 2025.

The U.S. patent application “Reduction Of Waveguide Crosstalk With Sub-Wavelength Structures” Ser. No. 19/260,471, filed Jul. 5, 2025, is also a continuation-in-part of U.S. patent application “Disaggregated Memory Structures On A Directly Modulated Photonic Wafer-Scale Interposer” Ser. No. 19/243,462, filed Jun. 19, 2025.

The U.S. patent application “Disaggregated Memory Structures On A Directly Modulated Photonic Wafer-Scale Interposer” Ser. No. 19/243,462, filed Jun. 19, 2025, is also a continuation-in-part of U.S. patent application “Optical Links With Degree Of Freedom VCSEL Modulation On A Photonic Wafer-Scale Interposer” Ser. No. 19/235,870, filed Jun. 12, 2025.

The U.S. patent application “Optical Links With Degree Of Freedom VCSEL Modulation On A Photonic Wafer-Scale Interposer” Ser. No. 19/235,870, filed Jun. 12, 2025, is also a continuation-in-part of U.S. patent application “Optical Link With VCSEL Wavelength Modulation” Ser. No. 19/230,233, filed Jun. 6, 2025.

The U.S. patent application “Optical Link With VCSEL Wavelength Modulation” Ser. No. 19/230,233, filed Jun. 6, 2025, is also a continuation-in-part of U.S. patent application “Optical Link With Modulation Of VCSEL Modes” Ser. No. 19/223,614, filed May 30, 2025.

The U.S. patent application “Optical Link With Modulation Of VCSEL Modes” Ser. No. 19/223,614, filed May 30, 2025, is also a continuation-in part of U.S. patent application “Optical Link With Polarization-Switched VCSEL Modulation” Ser. No. 19/222,606, filed May 29, 2025.

The U.S. patent application “Optical Link With Polarization-Switched VCSEL Modulation” Ser. No. 19/222,606, filed May 29, 2025, is also a continuation-in-part of U.S. patent application “Hierarchical Redundancy With Parallel Optical Links” Ser. No. 19/211,446, filed May 19, 2025.

The U.S. patent application “Hierarchical Redundancy With Parallel Optical Links” Ser. No. 19/211,446, filed May 19, 2025, is also a continuation-in-part of U.S. patent application “Waveguides Based On Nanoimprint Lithography On A Photonic Wafer Scale Interposer” Ser. No. 19/210,116, filed May 16, 2025.

The U.S. patent application “Waveguides Based On Nanoimprint Lithography On A Photonic Wafer Scale Interposer” Ser. No. 19/210,116, filed May 16, 2025, is also a continuation-in-part of U.S. patent application “Photonic Wafer-Scale Interposer With Mirrors Based on Nanoimprint Lithography” Ser. No. 19/192,587, filed Apr. 29, 2025.

The U.S. patent application “Photonic Wafer-Scale Interposer With Mirrors Based on Nanoimprint Lithography” Ser. No. 19/192,587, filed Apr. 29, 2025, is also continuation-in-part of U.S. patent application “Photonic Wafer-Scale Interposer With Micro Transfer Printed VCSELS And Back Side Power Delivery” Ser. No. 19/192,146, filed Apr. 28, 2025.

The U.S. patent application “Photonic Wafer-Scale Interposer With Micro Transfer Printed VCSELS And Back Side Power Delivery” Ser. No. 19/192,146, filed Apr. 28, 2025, is also a continuation-in-part of U.S. patent application “Photonic Wafer Scale Interposer With Integrated Crystallographic Etched Mirrors And Pre-Angled Light” Ser. No. 19/189,471, filed Apr. 25, 2025.

The U.S. patent application “Photonic Wafer Scale Interposer With Integrated Crystallographic Etched Mirrors And Pre-Angled Light” Ser. No. 19/189,471, filed Apr. 25, 2025, is also a continuation-in-part of U.S. patent application “Photonic Wafer Scale Interposer With Angled Beam Grating Couplers” Ser. No. 19/188,057, filed Apr. 24, 2025.

The U.S. patent application “Photonic Wafer Scale Interposer With Angled Beam Grating Couplers” Ser. No. 19/188,057, filed Apr. 24, 2025, is also a continuation-in-part of U.S. patent application “Back Side Power Delivery For Wafer-Scale Integration With An Isometric Grid Array With Compression Pins” Ser. No. 19/177,834, filed Apr. 14, 2025.

The U.S. patent application “Back Side Power Delivery For Wafer-Scale Integration With An Isometric Grid Array With Compression Pins” Ser. No. 19/177,834, filed Apr. 14, 2025, is also a continuation-in-part of U.S. patent application “Back Side Power Delivery For Wafer-Scale Integration With Laser Assisted Bonding” Ser. No. 19/093,546, filed Mar. 28, 2025.

The U.S. patent application “Back Side Power Delivery For Wafer-Scale Integration With Laser Assisted Bonding” Ser. No. 19/093,546, filed Mar. 28, 2025, is also a continuation-in-part of U.S. patent application “Photonic Wafer-Scale Interposer With Tapered Waveguides” Ser. No. 19/079,851, filed Mar. 14, 2025.

The U.S. patent application “Photonic Wafer-Scale Interposer With Tapered Waveguides” Ser. No. 19/079,851, filed Mar. 14, 2025, is also a continuation-in-part of U.S. patent application “Back Side Power Delivery For Wafer-Scale Integration With An Isometric Grid Compression Plate” Ser. No. 19/056,456, filed Feb. 18, 2025, which claims the benefit of U.S. provisional patent applications “Chiplet-Based Optical Wafer-Scale Network Switch” Ser. No. 63/750,817, filed Jan. 29, 2025, and “Wafer-Scale Integration Power Delivery With An Isotropic Conductive Adhesive” Ser. No. 63/750,822, filed Jan. 29, 2025.

The U.S. patent application “Back Side Power Delivery For Wafer-Scale Integration With An Isometric Grid Compression Plate” Ser. No. 19/056,456, filed Feb. 18, 2025, is also a continuation-in-part of U.S. patent application “Back Side Power Delivery For Wafer-Scale Integration With Solderless Modular Power Substrates” Ser. No. 19/023,647, filed Jan. 16, 2025, which claims the benefit of U.S. provisional patent applications “Cooling For Wafer-Scale Integration With Back Side Power Coupling” Ser. No. 63/714,353, filed Oct. 31, 2024, and “Back Side Wafer-Scale Power Delivery With An Anisotropic Conductive Film” Ser. No. 63/720,216, filed Nov. 14, 2024.

The U.S. patent application “Back Side Power Delivery For Wafer-Scale Integration With Solderless Modular Power Substrates” Ser. No. 19/023,647, filed Jan. 16, 2025, is also a continuation-in-part of U.S. patent application “Wafer-Scale Integration With A Stiffening Isometric Grid Array” Ser. No. 18/978,188, filed Dec. 12, 2024, which claims the benefit of U.S. provisional patent applications “Cooling for Wafer-Scale Integration With Back Side Power Coupling” Ser. No. 63/714,353, filed Oct. 31, 2024, and “Back Side Wafer-Scale Power Delivery With An Anisotropic Conductive Film” Ser. No. 63/720,216, filed Nov. 14, 2024.

The U.S. patent application “Wafer-Scale Integration With A Stiffening Isometric Grid Array” Ser. No. 18/978,188, filed Dec. 12, 2024, is also a continuation-in-part of U.S. patent application “Cold Plate Cooling For Wafer-Scale Integration With Back Side Modular Power Delivery” Ser. No. 18/958,107, filed Nov. 25, 2024, which claims the benefit of U.S. provisional patent applications “Cooling for Wafer-Scale Integration With Back Side Power Coupling” Ser. No. 63/714,353, filed Oct. 31, 2024, and “Back Side Wafer-Scale Power Delivery With An Anisotropic Conductive Film” Ser. No. 63/720,216, filed Nov. 14, 2024.

The U.S. patent application “Cold Plate Cooling For Wafer-Scale Integration With Back Side Modular Power Delivery” Ser. No. 18/958,107, filed Nov. 25, 2024, is also a continuation-in-part of U.S. patent application “Back Side Wafer-Scale Integration With Modular Power Delivery” Ser. No. 18/940,944, filed Nov. 8, 2024, which claims the benefit of U.S. provisional patent application “Cooling for Wafer-Scale Integration With Back Side Power Coupling” Ser. No. 63/714,353, filed Oct. 31, 2024.

Each of the foregoing applications is hereby incorporated by reference in its entirety.

### FIELD OF ART

This application relates generally to transmitting data and more particularly to dynamic redundancy with parallel optical links.

### BACKGROUND

Interhuman communications, which have evolved over many millennia, come in many forms including visual, nonverbal, verbal, and written ones. Some researchers believe visual and nonverbal communication came first, likely developed around 100,000 years ago. These communication formats relied on body and hand gestures, facial expressions, and non-word vocalizations. A shoulder shrug, a finger pointing toward game, or a smile could indicate uncertainly, opportunity, and welcome, respectively. Roughly 30,000 years ago, pictorial communications are believed to have been developed. Early pictorial communications included cave paintings discovered in France and Spain and are considered to convey significant rituals, hunts, and other important events. Another form of pictorial communication includes handprints left by Australian Aboriginal people. These prints are thought to indicate a record of presence, cultural stories, and a connection to the land. Native American painted pictographs related stories and connected people to the natural and spiritual worlds.

Pictorial representations eventually evolved into glyphs with examples including Egyptian hieroglyphs, Mayan cenotes, and Sumerian cuneiforms that were based on logographs representing words or ideas and syllabograms representing sounds. And Native American petroglyphs are through to date back up to 10,500 years. Perhaps the most intriguing are geoglyphs which are large designs or motifs created on the ground. Written languages evolved from the pictorial ones and were developed along with spoken languages. Using spoken and written languages, humans were able to exchange more complex concepts. Events and stories articulating culturally important history, lore, and traditions were recorded and shared.

The invention of the wooden moveable type printing press in China, enhanced with metal movable type by Gutenberg in the 15^{th} century, enabled recording, storage, and exchange of important, significant, and often religious information. Printed materials, whether pamphlets, books, or newspapers, could be transported and shared with people near and far. As humans became more mobile with transportation improvements, new communication devices were developed that could send information across vast distances. The early 18^{th} century concept of sending information over long distances using electrical signals came to fruition with Morse's telegraph of the 1830s. The telephone, patented by Bell in 1867, enabled sending voice over great distances. And Marconi's credited invention of radio in 1902 finally enabled wireless communication over long distances.

Digital communication, developed in the late 20^{th} century, enabled interhuman communication virtually anywhere. Some digital communications are instantaneous and transient, while others are persistent. Instantaneous digital communications include live chat, instant messaging, and video conferencing. This form of digital communication is for immediate consumption and is rarely recorded. Social media, websites, blogs, and podcasts are examples of nonimmediate digital communication. These latter digital communication types can remain accessible and be examined repeatedly. Some digital communication is now driven by AI. AI chatbots, among other AI systems, interact with humans using natural language. Thus, communications continue to change, evolve, and hopefully improve.

### SUMMARY

The need for improved processor performance is driven by endlessly increasing user and application demand. Applications that are especially computationally intensive, such as artificial intelligence (AI), climate modeling, genome sequencing, and so on, have been hobbled by current technological capabilities of processors, systems-on-chip (SoCs), accelerators, servers, memory, power delivery, cooling technologies, communications, and so on. All of these applications and others confirm that increased processing performance is broadly needed. For example, today's large language model (LLM) training time can be measured in months, even if utilizing many processors and accelerators that are executing around the clock. Accomplishing further processor and communication improvements will require advances in all system components. For example, communications between processors, accelerators, transformers, and so on, must keep pace with the computational performance of these processing elements by transmitting data to the processing elements. Otherwise, these processing elements become “starved” for data and stall. When processing elements stall, irrespective of their processing speed, overall system performance remains unimproved because processing advantages of the processors are lost to idle times while stalled. Processing speed, memory access speed (latency), data transfer bandwidth, and power consumption are all critical to overall system performance, whether related to today's high performance systems or to the systems that will be created in the future.

Disclosed techniques enable improved transmitting of data. The transmitting of data is enabled by dynamic redundancy with parallel optical links. A first circuit is coupled to a second circuit. The coupling is based on a first optical link. The first optical link includes a first optical source and a first optical medium. The first optical source can include a ring resonator, a vertical-cavity surface-emitting laser (VCSEL), etc. The optical medium can include a fiberoptic cable, a multicore fiber cable, a waveguide, and so on. The plurality of optical links includes a plurality of spare optical links. Data is sent by the first circuit to the second circuit. The sending is based on the first optical link. The optical links are tested, based on a round robin protocol. The testing includes determining a failure within the first optical link. The first optical link is replaced with a second optical link. The second optical link is within the spare optical links. The replacing is transparent to the sending.

A method for transmitting data is disclosed comprising: coupling a first circuit within a plurality of circuits to a second circuit within the plurality of circuits, wherein the coupling is based on a first optical link within a plurality of optical links, wherein the plurality of optical links includes a plurality of spare optical links; sending data, by the first circuit to the second circuit, wherein the sending is based on the first optical link; testing the plurality of optical links, wherein the testing is based on a round robin protocol, wherein the testing includes determining a failure within the first optical link; and replacing the first optical link with a second optical link, wherein the second optical link is within the plurality of spare optical links, and wherein the replacing is transparent to the sending.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for dynamic redundancy with parallel optical links.

FIG. 2 is a flow diagram for transmitting data.

FIG. 3 is a diagram for replacing an optical link on a photonic wafer-scale interposer (PWSI).

FIG. 4 is an example of a waveguide.

FIG. 5 is an example of a vertical-cavity surface-emitting laser (VCSEL).

FIG. 6 is an apparatus for dynamic redundancy with parallel optical links.

FIG. 7 is a system diagram for dynamic redundancy with parallel optical links.

### DETAILED DESCRIPTION

Techniques for transmitting data based on dynamic redundancy with parallel optical links are disclosed. The capabilities of today's processors and other system elements such as memories and data switches are overwhelmed by modern applications such as artificial intelligence (AI), machine learning (ML), weather forecasting, market analysis, and so on. The amounts of data required for training AI, ML, and other models strain or saturate conventional communications configurations, thus driving the endless demand for faster and more efficient data access and transfer techniques. Significant demand also exists for faster processors with expanded capabilities to handle these computationally complex applications. To address the increasing demands, high performance systems-on-chip (SoCs) have been designed. The SoCs can include processors such as multiprocessors, cores, memories, switching elements, and so on. These SoCs can propel transistor counts into the tens of billions. Other devices that boost system-level performance include accelerators such as artificial intelligence (AI) accelerators. These accelerators have been designed and developed to offload and accelerate computationally complex calculations performed by networks such as artificial neural networks. In a usage example, today's large language models can depend on many such scaled-out accelerators to perform training and inferencing. As raw processing power increases, data transmission links such as optical links are called upon to provide sufficient bandwidth and speed to support system performance. However, dedicated, high reliability optical links are complex and expensive. Instead, large numbers of inexpensive redundant optical links can be used. If an optical link degrades or fails, the link is replaced with a spare link. The replacing of the degraded or failed link is transparent to the sending of the data.

Another approach to boosting system performance has been to enable high speed communications between and among circuits, chiplets, cores, etc. The circuits can be co-located on a circuit board, wafer, or interposer, or can be located remotely from each other. In order for the circuits to continue processing without stalling, instructions, data, and so on must be delivered and accessed within a narrow amount of time. Such data exchanges are typically hampered by communication bottlenecks, resulting in interconnect that is not capable of keeping up with the circuits. Previously, simple bus architectures such as the Peripheral Component Interconnect (PCI) bus enabled sufficient bandwidth to keep processor elements from stalling. Stalling occurs when the processor elements are starved for data because the required data did not arrive in time. But as these elements grew in their ability to process more data more efficiently, additional methods of interconnect were developed. For example, high speed serial links such as PCI Express (PCIe) enabled Gigabit-per-second speeds on multiple “lanes.” As processing power has further increased, optical communications have become a low power, high bandwidth alternative to wire-based techniques for transferring data between processing elements. For example, multimode fibers enable remarkably high bandwidth short-reach optical links which can be used between server racks, switches, storage, and so on.

To address these data transmission issues, techniques for dynamic redundancy with parallel optical links are disclosed. A first circuit within a plurality of circuits is coupled to a second circuit within the plurality of circuits. The plurality of circuits can include chiplets, SoCs, ASICs, and so on. The coupling is based on a first optical link within a plurality of optical links. The first optical link includes a first optical source and a first optical medium. The plurality of optical links includes a plurality of spare optical links. Data is sent by the first circuit to the second circuit based on the first optical link. The data can include any data type and any data format. The data can be serialized data. The plurality of optical links is tested. The testing is based on a round robin protocol. The testing can also be based on a pseudo-random binary sequence (PRBS) pattern. The testing includes determining a failure within the first optical link. The first optical link is replaced with a second optical link. The second optical link is within the plurality of spare optical links. The replacing is transparent to the sending.

An optical link includes an optical source and an optical medium. The light emitted by an optical source can be modulated. The modulating the light of an optical source enables sending data between a first circuit and a second circuit using an optical link. The first circuit and the second circuit can comprise chiplets, SoCs, wafers, ASICs, cores, cores on wafers, and so on. The circuits, chiplets, etc. can be bonded to a photonic wafer-scale interposer (PWSI). The first optical source can be based on a variety of light sources such as ring oscillators, vertical-cavity surface-emitting lasers (VCSELs), laser diodes, and so on. The first optical source can be a first VCSEL. The sending includes modulating a degree of freedom (DoF) of the first VCSEL. The first VCSEL is coupled to the first circuit. The modulating includes emitting, by the first VCSEL, a modulated light beam (MLB). The MLB is based on the data that was sent from the first circuit. The modulated light degree of freedom can include an intensity, a polarization, a mode, or a wavelength. The second circuit receives the modulated light beam from the first VCSEL. The data that is sent can be decoded. The decoding can include converting a modulated degree of freedom optical signal to an electrical signal.

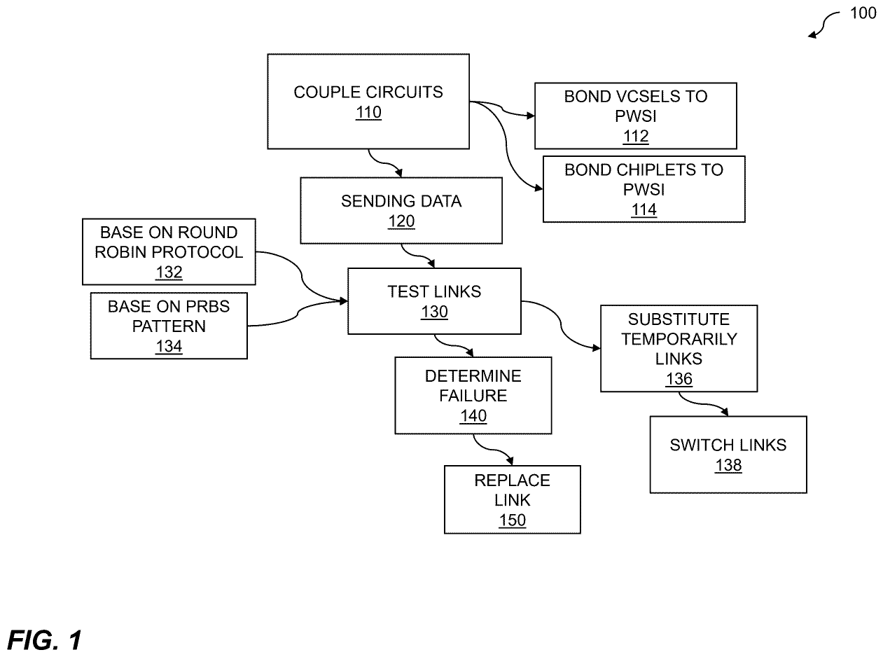

FIG. 1 is a flow diagram for dynamic redundancy with parallel optical links. The flow 100 includes coupling circuits 110. Embodiments include coupling a first circuit within a plurality of circuits to a second circuit within the plurality of circuits, wherein the coupling is based on a first optical link within a plurality of optical links, wherein the plurality of optical links includes a plurality of spare optical links. The plurality of circuits can include chiplets that perform a variety of functions such as artificial intelligence (AI) acceleration, switching, data processing of various data types, and so on. The plurality of circuits can include cores such as processor cores, cores fabricated on or coupled to a wafer, and the like. In embodiments, the first optical link includes a first optical source and a first optical medium. The first optical source can include a surface-emitting light source. In embodiments, the first optical source comprises a ring resonator. A ring resonator can guide one or more wavelengths of light. The ring resonator can “resonate” at the one or more wavelengths and can act as a filter of some wavelengths and an amplifier of other wavelengths. The optical source can include other surface-emitting light sources such as vertical-cavity surface-emitting lasers (VCSELs), laser diodes, light emitting diodes (LEDs), etc. The first optical medium can include a variety of optical media. In embodiments, the first optical medium comprises a fiberoptic cable. The fiberoptic cable can enable sending data with low loss. In other embodiments, the first optical medium comprises a multicore fiber cable. The multicore fiber cable can comprise a plurality of optical cores such as optical fibers, where each core can be used to send data. In other embodiments, the first optical medium comprises a first waveguide within a plurality of waveguides within a photonic wafer-scale interposer (PWSI) (discussed below).

The flow 100 includes bonding VCSELS to a PWSI 112. In embodiments, the first optical source includes a first vertical-cavity surface-emitting laser (VCSEL) within a plurality of VCSELs bonded to a photonic wafer-scale interposer (PWSI). The PWSI can comprise a silicon wafer, a glass wafer, and so on. The PWSI can include a plurality of VCSELS which can be modulated. Therefore, in embodiments, the PWSI comprises a directly modulated PWSI. The first VCSEL can include a single VCSEL, a plurality of VCSELs such as an array of VCSELS, a chip which includes one or more VCSELS, and so on. The first VCSEL can be fabricated and transferred to the PWSI for bonding to the PWSI. The bonding can be accomplished using one or more adhesives, one or more elastomeric sheets, soldering techniques such as solder balls or a ball grid array, laser assisted bonding, and the like. The bonding the VCSEL to the PWSI can comprise coupling the VCSEL to wires, interconnects, and so on, on and within the PWSI. The flow 100 include bonding chiplets to the PWSI 114. In embodiments, the plurality of circuits comprises a plurality of chiplets, wherein the plurality of chiplets is bonded to the PWSI. Described throughout, the chiplets can include processors, cores, memories, ASICs, SoCs, and so on. The bonding the chiplets to the PWSI can include coupling the chiplets to metal layers, interconnect, wires, etc. on and within the PWSI.

The flow 100 includes sending 120 data. Embodiments include sending data, by the first circuit to the second circuit, wherein the sending is based on the first optical link. The data that can be sent can include any type of data in any format. In a usage example, the data can include weights for an artificial intelligence (AI) model. The data can include bytes, words, and so on. The data can include serialized data. In embodiments, the sending includes modulating a degree of freedom (DoF) of the first VCSEL, wherein the first VCSEL is coupled to the first circuit, wherein the modulating includes emitting, by the first VCSEL, a modulated light beam (MLB), wherein the MLB is based on the data that was sent from the first circuit.

The modulating a degree of freedom can be based on various techniques. In embodiments, the degree of freedom comprises an intensity of the first VCSEL. In a usage example, the intensities of light can include a high intensity that can represent a logic one and a low intensity that can represent a logic zero. The low intensity can include no light emission from the first VCSEL. In embodiments, the degree of freedom comprises a polarization of the first VCSEL. The polarization can include an s-polarization, which includes polarization that is normal or perpendicular to a surface of incidence, or a p-polarization, which includes polarization that is parallel to a surface of incidence. The polarization can be controlled by asymmetric current injection. In embodiments, the degree of freedom comprises a mode of the first VCSEL. A mode can include a transverse electromagnetic (TEM) mode. In a usage example, the TEM modes can include TEM₀₀, TEM₁₀, and TEM₀₁. The TEM₀₀ mode can comprise a fundamental mode, while the TEM₁₀ mode and the TEM₀₁ mode can comprise higher order modes. In embodiments, the degree of freedom comprises a wavelength of the first VCSEL. In a usage example, the wavelength modulation is based on a VCSEL chirp. The VCSEL chirp can be induced by current injection.

The flow 100 includes testing links 130. Embodiments include testing the plurality of optical links, wherein the testing is based on a round robin protocol, wherein the testing includes determining a failure within the first optical link. The testing can be performed to determine a state or “health” of an optical link. In a usage example, the state of an optical link can include “healthy,” “degraded/failing,” “failed,” and so on. The testing can be performed by a controller, a processor, and the like coupled to the PWSI. The controller, processor, etc. can be bonded to the PWSI or can be physically separate from the PWSI. The testing can be accomplished by providing data such as a test set of numbers, characters, and so on to an optical link, and confirming that the test set is received correctly at the far end of the optical link. The optical link can be tested for physical integrity. In a usage example, a test can include time domain reflectometry (TDR).

In the flow 100, the testing is based on a round robin protocol 132. A round robin protocol can allocate an amount of time such as an equal amount of time to testing each optical link within the plurality of optical links. The round robin protocol further ensures that each optical link is tested within a designated window of time. The testing can be performed by sending data through the optical link under test and confirming that the data is successfully sent. In some embodiments, the testing is based on a pseudo-random binary sequence (PRBS) pattern 134. A PRBS pattern can enable testing by comprising a “pseudo-random” sequence of binary digits that is generated deterministically. That is, while the sequence of binary digits appears random, the sequence is repeatable. The random sequence of digits can simulate real data streams and test the ability of the optical link to handle patterns including complex patterns. Other testing methods, protocols, patterns, and so on can be implemented.

The flow 100 includes substituting, temporarily, the links 136. In some embodiments, the testing includes substituting temporarily the first optical link with an additional optical link, wherein the additional optical link is within the plurality of spare optical links. When a link is in operation, it cannot be tested unless operation is paused, halted, stopped, etc. However, because a plurality of spare optical links is included within the PWSI, a spare optical link can be substituted for the first optical link. This allows the first optical link to be tested while operations continue to progress using the spare link. Note that the substituting temporarily can be a part of the round robin testing, such that operational links can be testing on a schedule. Note that there does not have to be suspicion that the first optical link is failing. The testing can occur transparent to the user. The flow 100 includes switching links 138. Some embodiments include switching the additional optical link with the first optical link, wherein the switching occurs after the first optical link is tested. Once the first optical link is tested and found to be operational, the additional optical link, which was a spare link, can be switched with the first optical link. Thus, the additional optical link can be used in the future as a spare link. This can allow for future testing of the additional optical link. Thus, disclosed embodiments provide a means for testing operational links in a way that is transparent to a user.

The flow 100 includes determining 140 a failure within the first optical link. The testing can determine a state of an optical link, a status of the optical link, and so on. The testing can determine if an optical link is performing correctly, is underperforming or failing, or has failed. The results of the testing the optical links within the plurality of optical links can be stored for later update and use. In a usage example, the testing results are stored in a table that is accessible to a test controller. Once an optical link is determined by testing to be failing, to have degraded, or to have failed, the optical link can be marked for nonuse.

The flow 100 includes replacing a link 150. Embodiments include replacing the first optical link with a second optical link, wherein the second optical link is within the plurality of spare optical links, and wherein the replacing is transparent to the sending. The second optical link can be the additional optical link (explained above) or another optical link in the plurality of spare optical links. When an optical link fails, a spare optical link can be selected from within the plurality of spare optical links and used to replace the failing or failed optical link. In a usage example, a controller can perform the replacement. The controller can maintain and access a list, a table, an array, etc. of spare optical links within the plurality of optical links. The controller can select a spare link and replace the first link with the spare second link. In some embodiments, the second optical link comprises a second VCSEL within the plurality of VCSELs, wherein the second optical link comprises a second waveguide within the plurality of waveguides. The replacement of the first optical link by the second optical link can be performed “on the fly,” enabling the replacement to be transparent to the sending. In a usage example, the replacing can be accomplished using a demultiplexer (dmux) to steer sent data to a replacement optical link and a multiplexer (mux) to direct the data from the selected optical link to the second circuit.

Various steps in the flow 100 may be changed in order, repeated, omitted, or the like without departing from the disclosed concepts. Various embodiments of the flow 100, or portions thereof, can be included in an apparatus for transmitting data or system that is configured to transmit data.

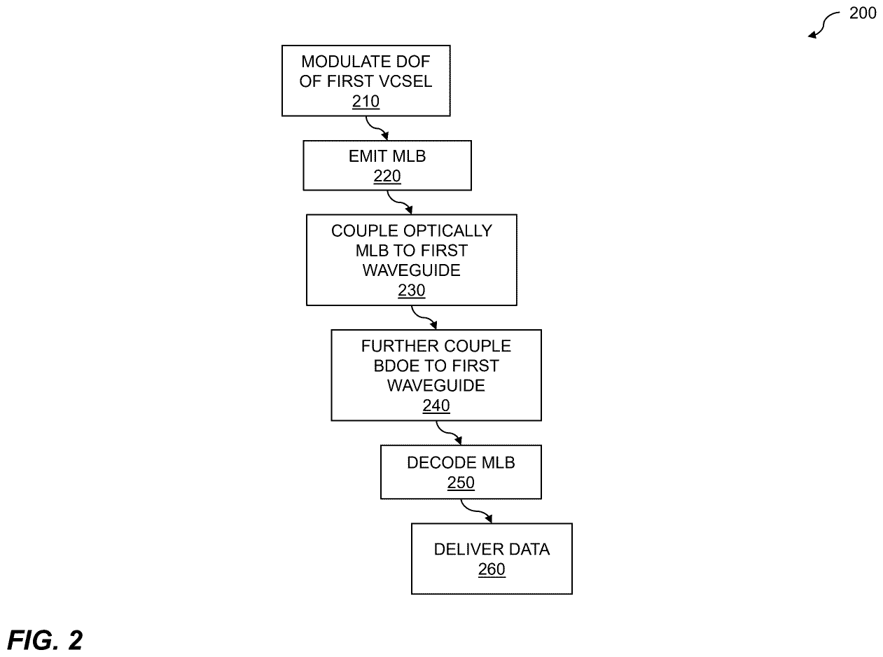

FIG. 2 is a flow diagram for transmitting data. Data is transmitted between circuits, where the transmitting data is accomplished based on dynamic redundancy with parallel optical links. Circuits such as chips, chiplets, cores, and so on communicate optically using optical links within a plurality of optical links. Some of the links can be designated as spare links. The optical links are based on optical sources and optical media. The optical sources can include light emitting sources such as ring resonators, vertical-cavity surface-emitting lasers (VCSELs), laser diodes, and the like. The optical media can include waveguides, fiberoptic cables, multicore fiber cables, etc. The optical links (which can be inexpensive) can be used in place of costly, high reliability links. A substantial number of optical links can be fabricated on or in a circuit board, wafer, or interposer such as a photonic wafer-scale interposer. The optical links can degrade or fail over time. To determine the operational status of the optical links, testing of each link is performed. When the test results of a given optical link indicate that the link is failing or has failed, a controller can swap out the failing or failed link and replace it with a spare link. The replacing of the failed link is transparent to the sending data.

A first circuit within a plurality of circuits is coupled to a second circuit within the plurality of circuits. The coupling is based on a first optical link within a plurality of optical links. The plurality of optical links includes a plurality of spare optical links. Data is sent by the first circuit to the second circuit. The sending is based on the first optical link. The plurality of optical links is tested. The testing is based on a round robin protocol. The testing includes determining a failure within the first optical link. The first optical link is replaced with a second optical link. The second optical link is within the plurality of spare optical links. The replacing is transparent to the sending.

The flow 200 includes modulating a degree of freedom of the first VCSEL 210. Recall that the sending can be based on modulating light emitted from a light source, such as a first VCSEL, associated with the PWSI. Thus, in some embodiments, the PWSI comprises a directly modulated PWSI. In some embodiments, the sending includes modulating a degree of freedom (DoF) of the first VCSEL, wherein the first VCSEL is coupled to the first circuit, wherein the modulating includes emitting, by the first VCSEL, a modulated light beam (MLB), wherein the MLB is based on the data that was sent from the first circuit. Various degrees of freedom can be modulated. In embodiments, the degree of freedom comprises an intensity of the first VCSEL. In a usage example, the intensity of the VCSEL can be increased or decreased based on current applied to the VCSEL. In embodiments, the degree of freedom comprises a polarization of the first VCSEL. In a usage example, the degree of freedom based on polarization can include an s-polarization, which includes polarization that is normal or perpendicular to a surface of incidence, or a p-polarization, which includes polarization that is parallel to a surface of incidence. The polarization can be controlled by asymmetric current injection. In embodiments, the degree of freedom comprises a mode of the first VCSEL. A mode can include a transverse electromagnetic (TEM) mode. In a usage example, the TEM modes can include TEM₀₀, TEM₁₀, and TEM₀₁. The TEM₀₀ mode can comprise a fundamental mode, while the TEM₁₀ mode and the TEM₀₁ mode can comprise higher order modes. In embodiments, the degree of freedom comprises a wavelength of the first VCSEL. In a usage example, the wavelength modulation is based on a VCSEL chirp. The VCSEL chirp can be induced by the current injection.

In the flow 200, the modulating includes emitting 220, by the first VCSEL, a modulated light beam (MLB), wherein the MLB is based on the data that was sent from the first circuit. Discussed previously and throughout, a surface-emitting light source such as the first VCSEL can emit light based on data sent from the first circuit. Other surface-emitting light sources such as a ring resonator, a laser diode, a light emitting diode (LED) and so on can be used. Discussed above, an electrical current is applied to the VCSEL in order for the VCSEL to lase and to emit light. The electrical current can be applied to a top p-Distributed Bragg Reflector mirror of the VCSEL using a p contact, and the electrical current can exit a bottom n-Distributed Bragg Reflector mirror of the VCSEL using an n contact. The electrical current can flow, by definition, from the p contact to the n contact. The MLB from the VCSEL can be emitted at an angle that can be substantially normal to a substrate to which the VCSEL can be coupled. When the light emitted by the VCSEL needs to be angled, then an optical device can be used. The light emitted by the VCSEL might need to be angled to compensate for device variations, coupling techniques, etc. A usage example can include angling the light that was emitted by the first optical source, wherein the angling is based on a micro-optical element (MOE). The MOE can be based on a lens, a grating, a bent waveguide, and so on.

The flow 200 further include coupling optically the MLB to the first waveguide 230. Some embodiments include coupling optically, by a first optical coupler, the MLB to the first waveguide. The coupling optically can be based on a variety of optical coupler techniques. In a usage example, an optical coupler comprises a mirror. The mirror can be fabricated using a nanoimprint lithography (NIL) process. Structures fabricated by the NIL process can be coated with a reflective material. In another usage example, an optical coupler comprises a bent waveguide. The bent waveguide can include a high-containment region of a waveguide which minimizes loss of light from the waveguide. In a usage example, an optical coupler comprises a grating coupler. A grating coupler can be positioned at an angle. The grating coupler, which can include a periodic coupler, can be tuned to maximize transfer of the wavelength of light or a band of wavelengths of light. In a further usage example, the optical coupler can include an off-axis diffractive lens. The off-axis diffractive lens can focus light at a point that is unaligned with the optical axis of the lens. The off-axis diffractive lens can redirect the MLB from the first VCSEL into the first waveguide. Other optical coupler techniques can also be used.

The flow 200 includes further coupling a beam-dependent optical element (BDOE) to the first waveguide 240. In some embodiments, the first optical link includes a first BDOE, wherein the first BDOE is further coupled to the first waveguide. A BDOE can be an optical element that interprets a degree of freedom state of an optical signal. The BDOE can be used to decode the MLB at the far end of the waveguide. The flow 200 further includes decoding the MLB 250. Some embodiments include decoding, by the first BDOE, the MLB into the data that was sent. The BDOE can be based on a variety of decoding techniques. In a usage example, the BDOE comprises a grating coupler. The grating coupler can separate different degrees of freedom of light from each other. In a usage example, the separated degrees of freedom of light can be sent to optical receivers, where the optical receivers can convert the optical data to electrical data. In another usage example, the grating coupler can indicate when a first degree of freedom is active in the optical medium, which can comprise a logic “1.” The absence of the signal from the grating coupler can comprise a logic “0.” Clocking, such as clock and data recovery (CDR) circuits, can synchronize the modulated light beam with the receiving and/or decoding circuits. The optical decoding element can comprise a polarization filter. The polarization filter can enable a first polarization of light to pass through the polarization filter while a second polarization of light is reflected by the polarization filter. The optical decoding element can comprise a polarization multiplexor (PMUX). The polarization multiplexer can separate the different polarizations of the modulated light beam at the far end of the waveguide.

The flow 200 further includes delivering data 260. Some embodiments include delivering the data to the second circuit. The second circuit can be within the plurality of circuits bonded to the PWSI. The delivering data to the second circuit can be accomplished using wire, interconnect, metal layers, and so on. The metal layers can include metal layers within a circuit board, a wafer, an interposer, a PWSI, and so on. The metal layers, which enable interconnection between and among circuits, chiplets and other elements, can be fabricated on or within a board, wafer, interposer, etc. The metal layers can offer significant communications speed due to short wire lengths, and reduced “parasitics” such as resistance, capacitance, and inductance. The second circuit can process the delivered data, forward the delivered data, etc. In some embodiments, the first BDOE includes a first photodiode, wherein the delivering is based on the first photodiode. The first photodiode can convert optical data such as decoded data to electrical data. The electrical data can be delivered to the second circuit.

Various steps in the flow 200 may be changed in order, repeated, omitted, or the like without departing from the disclosed concepts. Various embodiments of the flow 200, or portions thereof, can be included in an apparatus for transmitting data or system that is configured to transmit data.

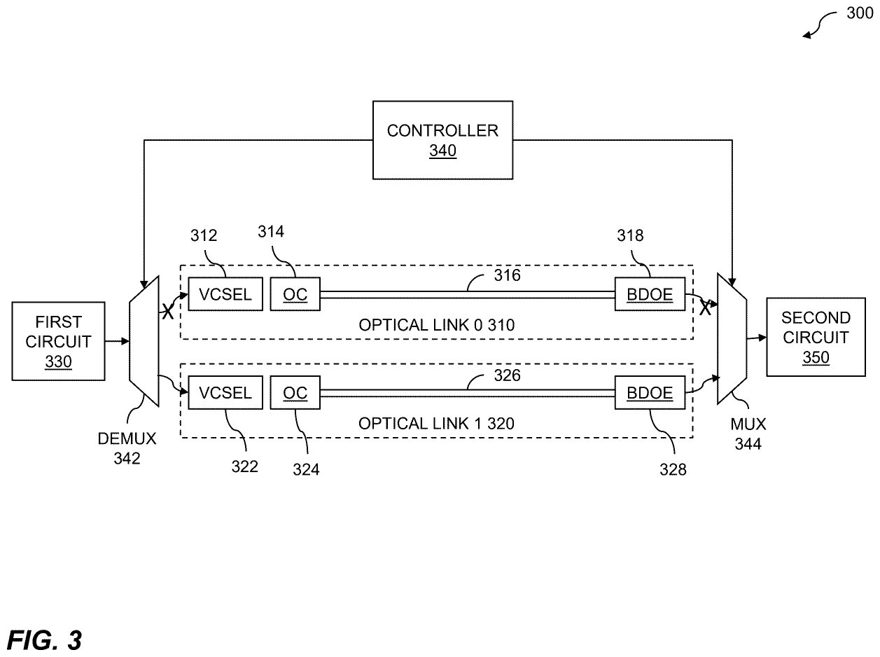

FIG. 3 is a diagram for replacing an optical link on a photonic wafer-scale interposer (PWSI). An optical link within a plurality of optical links can include an optical source and an optical medium. An optical link is used to send data between a first circuit and a second circuit. The first circuit is coupled to the second circuit via the optical link. The first circuit and the second circuit can comprise chiplets. The chiplets can be within a plurality of chiplets that are bonded to a wafer, a circuit board, an interposer, and so on. The interposer can include a directly modulated photonic wafer-scale interposer (PWSI). The plurality of optical links includes a plurality of spare optical links. The spare optical links can be dynamically coupled to the first circuit and the second circuit. Since elements associated with each optical link, such as the optical source and the optical medium, can underperform or fail, each optical link can be tested. The testing can include a round-robin protocol. When test results associated with an optical link indicate that the optical link is underperforming or failing, the optical link can be replaced by a spare optical link. The replacement can be transparent to the sending of data between the first circuit and the second circuit. Thus, replacing an optical link on a PWSI enables dynamic redundancy with parallel optical links.

The diagram 300 shows a plurality of optical links including optical link 0 310 and optical link 1 320. While two optical links are shown, the plurality of optical links can include other numbers of links, including operational links and spare links. In the FIG. 300, optical link 0 can comprise an operational optical link, and link 1 can comprise a spare optical link. The first optical link can be implemented in a variety of ways. In embodiments, the first optical link includes a first optical source and a first optical medium. Other elements can be included within an optical link. For example, optical link 0 includes an optical source 312, an optical coupler (OC) 314, an optical medium 316, and a beam dependent optical element (BDOE) 318. The optical source shown in optical link 0 includes a vertical-cavity surface emitting laser (VCSEL). The optical source can include other optical sources such as a laser diode, a light emitting diode, and the like. The optical sources can be modulated. In embodiments, the first optical source includes a first vertical-cavity surface-emitting laser (VCSEL), within a plurality of VCSELs bonded to a photonic wafer-scale interposer (PWSI). The PWSI can comprise a directly modulated PWSI. In other embodiments, the first optical source comprises a ring resonator. A mix of optical sources can be included within the plurality of optical links. The optical links couple a first circuit 330 and a second circuit 350. While two circuits are shown, the optical links can couple other numbers of circuits within the plurality of circuits.

The OC 314 can comprise a first optical coupler. The first optical coupler can couple light from the VCSEL to a first optical medium. A variety of techniques can be used to couple light from the VCSEL. An optical coupler can comprise a mirror, a bent waveguide, a grating coupler, an off-axis diffractive lens, and so on. An angle can be associated with a grating coupler. A mix of the above, or other, optical couplers can be used within the plurality of optical links. In embodiments, the first optical medium comprises a first waveguide within a plurality of waveguides within the PWSI. Other optical media can be used. In some embodiments, the first optical medium comprises a fiberoptic cable. In other embodiments, the first optical medium comprises a multicore fiber cable. A mix of the above optical links, or additional types of optical links, can be implemented. In embodiments, the first optical link includes a first beam-dependent optical element (BDOE), wherein the first BDOE is further coupled to the first waveguide. A BDOE can convert optical data into electrical data and can deliver that data to a second circuit.

In embodiments, the first BDOE includes a first photodiode, wherein the delivering is based on the first photodiode. Other BDOEs can be implemented, and a mix of BDOEs can be used within the plurality of optical links. Optical link 1 320 can comprise a second optical link, which can be a spare optical link. In embodiments, the second optical link is within the plurality of spare optical links. The second optical link can be implemented with any of the implementation options possible for the first optical link or a different one. For example, optical link 1 can also include a VCSEL 322, an OC 324, an optical medium 326, and a BDOE 328. In embodiments, the second optical link comprises a second VCSEL within the plurality of VCSELs. The second optical link can comprise other optical sources. In further embodiments, the second optical link comprises a second waveguide within the plurality of waveguides.

The optical links within the plurality of optical links can be tested. The testing can be performed by a controller 340. The testing also can be performed by a processor, a test processor, etc. The testing is based on a round robin protocol. A round robin protocol can allocate an amount of time such as an equal amount of time to testing each optical link, ensuring that each optical link is tested within a designated window of time. The testing can be performed by sending data through the optical link under test and confirming that the data is successfully sent. In some embodiments, the testing is based on a pseudo-random binary sequence (PRBS) pattern. A PRBS pattern can enable testing by comprising a random sequence of binary digits that is generated deterministically. The random sequence of digits can simulate real data streams and test the ability of the optical link to handle complex patterns. Other testing methods, protocols, patterns, and so on can be implemented. The testing can determine if an optical link is underperforming or has failed.

When an optical link fails, a spare optical link can be selected from within the plurality of spare optical links and used to replace the failing optical link. Embodiments include replacing the first optical link with a second optical link, wherein the second optical link is within the plurality of spare optical links. The controller can perform the replacement. The controller can maintain a list, a table, and so on of optical links that are allocated, spare optical links, underperforming and failed optical links, etc. The controller can control a demultiplexer (demux) 342 and a multiplexer (mux) 344. The demux can take an input signal from an input and route the signal to any of the outputs coupled to the demux. In the diagram 300, the demux input is the first circuit, and the demux outputs are the optical links. The mux can route a signal from any one of the inputs coupled to the mux to the output. Other types of multiplexers and demultiplexers can be used, including those with multiple inputs and multiple outputs. Recall that although only two optical links and two circuits are shown, other numbers of optical links and/or circuits can be coupled to the demux and mux. The selection of demux outputs and mux inputs can be performed by the controller 340. By controlling the demux and mux, the controller can route the signal from the first circuit to a selected optical link within the plurality of optical links and can route the output from the selected optical link to the second circuit. This control can enable the controller to route the signal from the first circuit to a spare optical link in the event that the first optical link underperforms or fails, thus replacing the first optical link with the second optical link, maintaining the coupling between the first circuit and the second circuit. In embodiments, the replacing is transparent to the sending. Transparency can mean that the sending of data from the first circuit to the second circuit is not substantially disrupted by the replacing. The controller can program the use of a spare optical link so that a failing link is removed from future use. The controller's programming of the mux and demux can be saved such that the coupling between the first circuit and second circuit can continue even after a power down and restart.

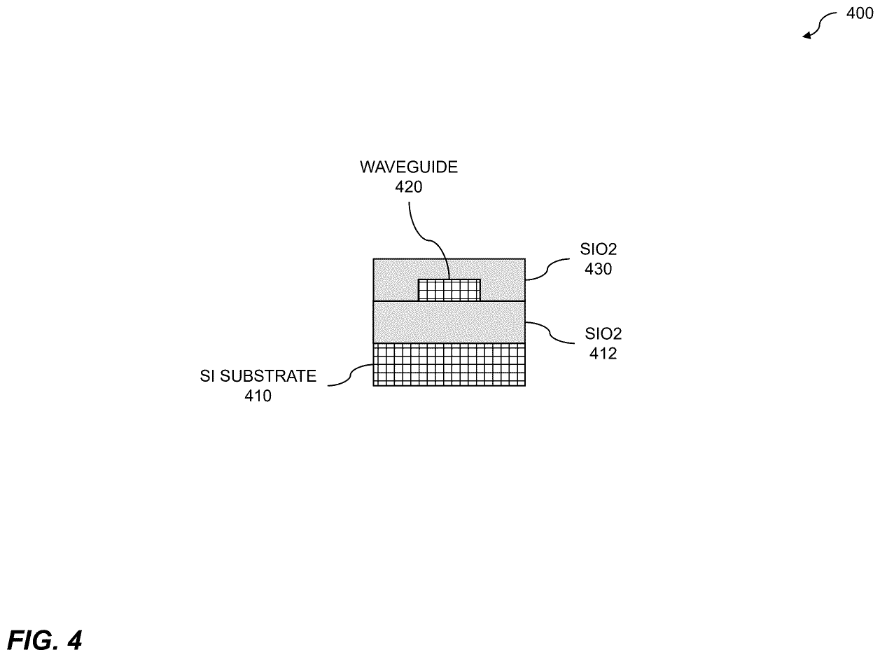

FIG. 4 is an example of a waveguide. The waveguide can comprise a waveguide within a plurality of waveguides, where the waveguides can be within an interposer. In a usage example, the waveguide can be based on a nanoimprint lithography process on a photonic wafer-scale interposer (PWSI). The waveguide can be fabricated in a technology such as a Silicon-on-Insulator (SOI) technology. A waveguide can be used to send a signal such as an optical signal between two elements such as circuits or chiplets. The sent signal can include sent data. The waveguide can be fabricated within a monolithic wafer which includes one or more circuits. The waveguide can be fabricated within a photonic wafer-scale interposer (PWSI), where the PWSI can be based on a wafer such as a silicon wafer, a glass wafer, and so on. The wafer can be used as a substrate for the PWSI. A plurality of waveguides can be fabricated within the PWSI in order to enable high speed, high bandwidth data transmission between circuits, such as chiplets, functional chips, and so on. The sending between chiplets can include chiplets separated by a long distance on the PWSI. The waveguides can be tapered. The tapering can include adiabatic tapering. The plurality of waveguides enables dynamic redundancy with parallel optical links.

The example 400 includes a cross-section of an example waveguide. The example waveguide can be fabricated in a Silicon-on-Insulator (SOI) technology as shown or in another fabrication technology. A silicon substrate 410 is used. The silicon substrate can include a silicon wafer, where the silicon wafer can include a 200 mm silicon wafer, a 300 mm silicon wafer, and so on. A silicon dioxide (insulator) layer 412 can be grown, deposited, or otherwise formed on the silicon wafer. One or more waveguides, such as waveguide 420, can be formed on the insulator layer. Any number of waveguides can be formed on the insulator layer. Another silicon dioxide insulator layer 430 can be placed over the one or more waveguides. The insulator layer can be planarized in order to enable fabrication of further elements on the silicon substrate. The waveguide can conduct light in order to establish optical communications between an optical source and a beam-dependent optical element (BDOE) within the PWSI. The waveguide can be utilized by a first chiplet. The first chiplet can send data to a first optical source such as a vertical-cavity surface-emitting laser (VCSEL), ring resonator, and so on. The VCSEL can convert the data from the first chiplet into optical data. The optical data can be coupled to a waveguide using an optical coupler such as a mirror fabricated using a nanoimprint lithography technique. The waveguide can be further coupled to a BDOE, which can decode the optical data into electrical data. The BDOE can be coupled to a second circuit and can deliver the electrical data to the second circuit.

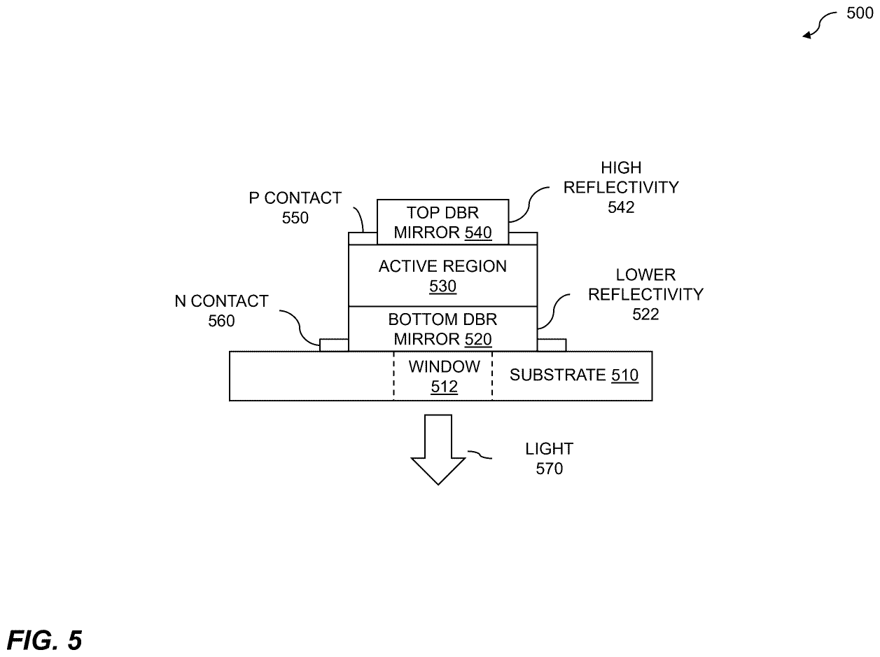

FIG. 5 is an example of a vertical-cavity surface-emitting laser (VCSEL). The VCSEL is shown in cross section. A plurality of optical sources, including a first optical source, can be bonded to a photonic wafer-scale interposer (PWSI). The interposer can be based on a wafer, such as a silicon wafer. The first optical source can be based on a variety of light emitting techniques. In embodiments, the first optical source includes a first vertical-cavity surface-emitting laser (VCSEL), within a plurality of VCSELs bonded to a photonic wafer-scale interposer (PWSI). A VCSEL can generate and emit coherent light. A degree of freedom of the VCSEL can be modulated. The modulated light can include a modulated light beam (MLB).

The degree of freedom can comprise an intensity, a polarization, a mode, a wavelength, and so on. One or more characteristics such as the above can enable conveyance of the light from the VCSEL into the PWSI. The characteristics can further enable coupling the light to a waveguide, and transmission of the light through the waveguide. The characteristics can further enable coupling the light from the waveguide to a beam-dependent optical element (BDOE). The VCSEL can be used to send data. Sending data is enabled using dynamic redundancy with parallel optical links.

The block diagram 500 includes a substrate 510. The substrate can be a thinned substrate. The thinned substrate can be based on a substrate that has been ground, polished, etched, and so on. The thinned substrate can include a variety of materials suitable for fabricating a VCSEL. In a usage example, the substrate can include a gallium-arsenide (GaAs) substrate. Other substrates that can be used can include aluminum-gallium-arsenide (AlGaAs), germanium (Ge), sapphire (Al₂O₃), and so on. The substrate can be thinned to enable fabrication of a window 512. Light is emitted by the VCSEL. The light emitted by the VCSEL can exit the VCSEL by passing through the window in the thinned substrate.

The VCSEL structure consists of an active region that is placed between two highly reflective mirrors. The first mirror includes a first reflectivity, and the second mirror includes a second reflectivity. In a usage example, the two highly reflective mirrors can be based on Distributed Bragg Reflectors (DBRs). The DBRs can be formed from multiple, alternating layers of materials, where the materials have different refractive indices. In the block diagram 500, a Distributed Bragg Deflector mirror can include a bottom mirror 520. The bottom mirror can include an n-Distributed Bragg Reflector. The bottom mirror can include a reflectivity that is lower than a top mirror (described below). In a usage example, the reflectivity 522 of the bottom DBR can include a reflectivity of 93 percent to 99 percent. Another reflectivity can be used. The n-Distributed Bragg Reflectors associated with the bottom mirror can be insulated from other layers in the block diagram by an oxide layer (not shown).

The block diagram 500 includes an active region 530. The active region can comprise a region in which light can be generated. The light can be generated using a variety of techniques. In a usage example, the active region can include a structure such as a quantum well structure. The active region can be located within a laser cavity. The block diagram 500 can include an additional oxide layer (not shown) between the active region and a top DBR mirror. The oxide layer between the bottom mirror and the active area, and the oxide layer between the active layer and the top mirror may or may not be present in the VCSEL. When present, the oxide layers can confine the light and electrical current within the active area. The block diagram 500 includes p-Distributed Bragg Reflector mirror 540. In the block diagram 500, the p-Distributed Bragg Reflector mirror comprises the top mirror of the VCSEL. The top mirror can include a reflectivity 542. In a usage example, the reflectivity of the top DBR can include a reflectivity of 99.4 percent to 99.9 percent. Another reflectivity can be used.

An electrical current is applied to the VCSEL in order for the VCSEL to lase and to emit light. The electrical current can be applied to the top p-Distributed Bragg Reflector mirror using a p contact 550. The electrical current can exit the bottom n-Distributed Bragg Reflector mirror using an n contact 560. The electrical current can flow from a p contact to an n contact. The VCSEL emits light 570. The light from the VCSEL can be emitted at an angle that can be substantially normal to a substrate to which the VCSEL can be coupled. When the light emitted by the VCSEL needs to be angled, then an optical device can be used. The light emitted by the VCSEL might need to be angled to compensate for device variations, coupling techniques, etc. A usage example can include angling the light that was emitted by the first optical source, wherein the angling is based on a micro-optical element (MOE). The MOE can be based on a lens, a grating, a bent waveguide, and so on.

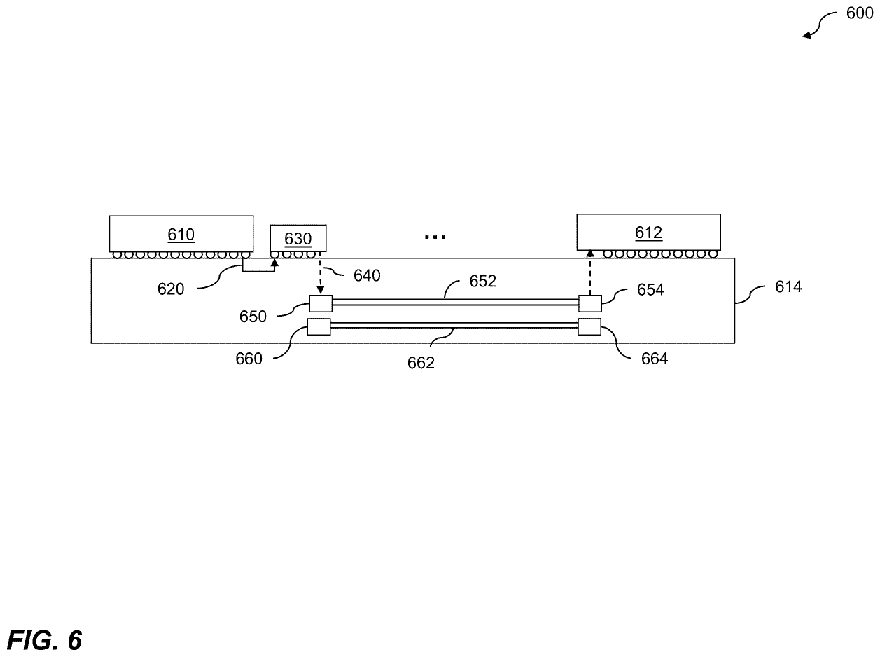

FIG. 6 is an apparatus for dynamic redundancy with parallel optical links. The apparatus enables the transmission of data between circuits, such as circuits bonded to a photonic wafer-scale interposer. Sending data can be accomplished using a first optical link within a plurality of optical links. The plurality of optical links includes a plurality of spare optical links. The first optical link enables sending data from a first circuit to a second circuit. In embodiments, the first circuit is coupled to the second circuit via a first optical link within the plurality of optical links, wherein the first circuit sends data to the second circuit based on the first optical link, and wherein the plurality of optical links includes a plurality of spare optical links. The first circuit and the second circuit can comprise chiplets bonded to a photonic wafer-scale interposer (PWSI). Various electronic and optical elements can be attached, bonded, mounted, or otherwise coupled to the PWSI. The electronic elements can include chiplets such as AI accelerators based on AI chiplets, network switches based on switching chiplets, memories, and so on. The optical elements can include optical modulators such as ring resonators, VCSELs, LEDs, laser diodes, photodiodes, and the like. The optical elements further include optical couplers such as mirrors, grating couplers, and bent waveguides; and optical mediums such as waveguides, fiberoptic cables, and multicore fiber cables.

An apparatus for transmitting data is disclosed comprising: a first circuit; a second circuit; a plurality of optical links, wherein the first circuit is coupled to the second circuit via a first optical link within the plurality of optical links, wherein the first circuit sends data to the second circuit based on the first optical link, and wherein the plurality of optical links includes a plurality of spare optical links; and a second optical link within the plurality of spare optical links, wherein the first optical link is replaced by the second optical link.

The apparatus 600 includes a first circuit 610 and a second circuit 612. The circuits can be connected, attached, bonded, or otherwise coupled to a circuit board, a wafer, an interposer 614 (such as a PWSI), and so on. While two circuits are shown, the apparatus can include any number of circuits. The circuits can include chiplets, input/output (I/O) chips, AI accelerators, switching circuits, ASICS, I/O circuits, processor cores, cores within and/or bonded to a wafer, and so on. The first circuit is coupled to the second circuit via a first optical link within a plurality of optical links. The first circuit sends data to the second circuit based on the optical link. The data can comprise any kind of data such as image data, video data, audio data; artificial intelligence (AI) weights, biases, and data; natural language data; and so on. In some embodiments, the first optical link includes a first optical source and a first optical medium. The first optical source can include a variety of optical sources that can be modulated. In other embodiments, the first optical source comprises a first vertical-cavity surface-emitting laser (VCSEL) within a plurality of VCSELs bonded to a photonic wafer-scale interposer (PWSI). Other optical sources are possible including a laser diode (LD), a light emitting diode (LED), and so on. In some embodiments, the first optical source comprises a ring resonator.

The first circuit 610 can send electrical data 620 to a first optical source 630. The electrical data can be sent using wires, interconnect, and so on associated with the PWSI. The electrical data can include any type of data, where the data can be represented by parallel data, serialized data, and the like. Noted previously, the first optical source can include a first vertical-cavity surface-emitting laser (VCSEL) within a plurality of VCSELs. The plurality of VCSELS can be bonded to a photonic wafer-scale interposer (PWSI). The sending can include modulating a degree of freedom (DoF) of the first VCSEL, where the first VCSEL is coupled to the first circuit. The degree of freedom can comprise an intensity, a polarization, a mode, a wavelength, and so on. The modulating can include emitting, by the VCSEL, a modulated light beam (MLB) 640. The MLB can be coupled to an optical medium via an optical coupler 650. The optical coupler can couple light from the optical source to the optical medium. Various optical couplers are possible including a mirror, a nanoimprint lithography (NIL) mirror, a bent waveguide, a grating coupler, and so on. The optical coupler enables coupling of the MLB to a first optical medium 652. In some embodiments, the first optical medium comprises a first waveguide within a plurality of waveguides within the PWSI. In other embodiments, the first optical medium comprises a fiberoptic cable. The fiberoptic cable can be used to couple optically an optical source on a first PWSI to an optical receiver, optical coupler, etc., that is remote to the first optical source. In a usage example, a fiberoptic cable can be used to connect circuits on separate circuit boards, on separate wafers, within different processors, within different data racks, within different data centers, etc. In other embodiments, the first optical medium comprises a multicore fiber cable. Other optical mediums are possible. The first optical link can include a beam-dependent optical element (BDOE) 654. In some embodiments, the first optical link includes a first beam-dependent optical element (BDOE), wherein the first BDOE is further coupled to the first waveguide. A BDOE can decode optical data into electrical data. Embodiments include decoding, by the first BDOE, the MLB into the data that was sent. Further embodiments include delivering the data to the second circuit.

The apparatus includes a plurality of optical links, wherein the first circuit is coupled to the second circuit via a first optical link within the plurality of optical links, wherein the first circuit sends data to the second circuit based on the first optical link, and wherein the plurality of optical links include a plurality of spare optical links. In the apparatus 600, the first optical link comprises an optical source 630 (which can include many optical sources), an optical coupler 650, an optical medium 652, and a BDOE 654. Recall that the PWSI can include a plurality of optical links. Many optical links (such as thousands, tens of thousands, hundreds of thousands, and so on) can be provided within the PWSI. Any element of an optical link, which can include one or more photodiodes, can operate with degraded performance or can fail. To ensure that a given optical link is operating properly, the plurality of optical links can be tested. The testing is based on a round robin protocol. A round robin protocol can allocate an equal amount of time to testing each optical link. The testing can be accomplished by testing each optical link sequentially, randomly, when the optical link is not in use, etc. The round robin testing ensures that each optical link is tested within a designated window of time. In some embodiments, the testing is based on a pseudo-random binary sequence (PRBS) pattern. A PRBS pattern can enable testing by comprising a random sequence of binary digits that is generated deterministically. The random sequence of digits can simulate real data streams and test the ability of the optical link to handle complex patterns. The deterministic generation can allow accurate identification of data that was sent incorrectly. In another usage example, the testing can be based on error rates of an optical link. An optical link that is failing or that has degraded performance can be replaced with a second optical link.

The apparatus includes a second optical link within the plurality of spare optical links, wherein the first optical link is replaced by the second optical link. Recall that the apparatus 600 includes a plurality of spare optical links. A second optical link can be within the plurality of spare optical links. The second optical link can comprise a second optical source (not shown), a second optical coupler 660, a second optical medium 662, and a second BDOE 664. Note that the optical source 630 can comprise a VCSEL, a chip with many VCSELS, an array of VSELS, and so on. Thus, the first optical source and the second optical source can be within the same chip, chiplet, etc., such as 630. In some embodiments, the second optical link comprises a second VCSEL within the plurality of VCSELs, and the second optical link comprises a second waveguide within the plurality of waveguides. In other embodiments, the second optical link comprises a second waveguide within the plurality of waveguides. The second optical link can be implemented with any of the implementation options possible for the first optical link or a different one. The replacing of the first optical link by the second optical link can be performed by a controller (not pictured). The controller can determine whether the first optical link is failing or has degraded performance and can replace the first optical link with the second optical link, such that the first circuit sends data to the second circuit via the second optical link. The replacement can be accomplished with a demultiplexer, multiplexer, or other means.

Though the first and the second circuits are pictured bonded to the same PWSI, the first and the second circuits could be located on a different or a common circuit board, a different or a common wafer, a different or a common rack, and so on. The first circuit and the second circuit can be remotely located with respect to each other. “Remotely located” can include locating the first circuit and the second circuit on separate circuit boards or wafers; separate multiprocessors, separate data racks, separate data centers, and so on.

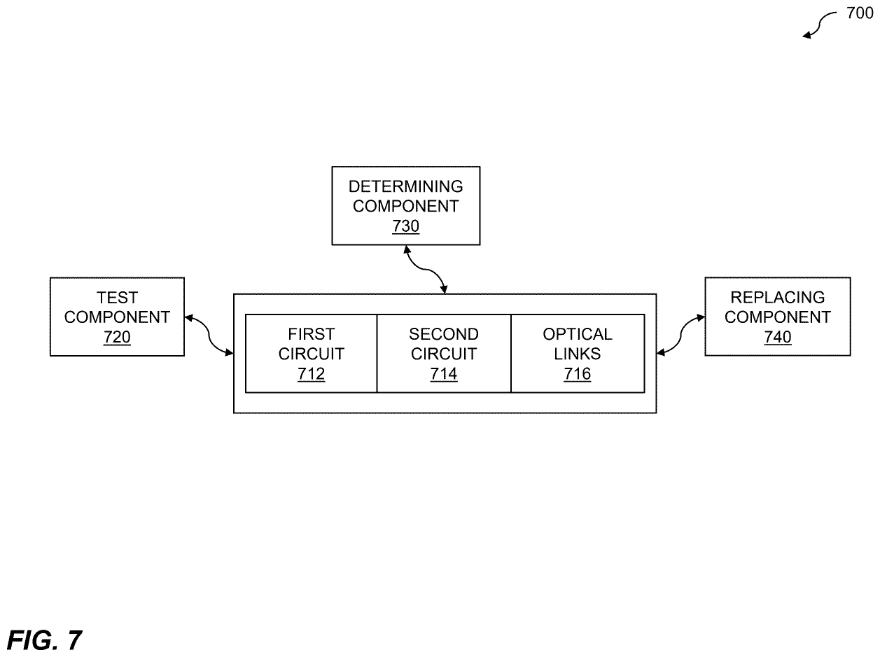

FIG. 7 is a system diagram for dynamic redundancy with parallel optical links. A plurality of optical links enables high-speed communications between a first circuit and a second circuit. High-speed communication includes sending data between the first circuit and the second circuit. The circuits can be within a plurality of circuits bonded to a photonic wafer-scale interposer (PWSI). In some embodiments, the plurality of circuits comprises a plurality of chiplets, wherein the plurality of chiplets is bonded to the PWSI. The first circuit and the second circuit can be located remotely from each other. The sent data can include electrical data such as serial electrical data. The first circuit is coupled to the second circuit. The coupling is accomplished via a first optical link within the plurality of optical links. The electrical data is converted to optical data and sent via the first optical link. The optical links can include an optical source and an optical medium. The optical source can include a vertical-cavity surface-emitting laser (VCSEL), a ring resonator, a laser diode, etc. The optical source converts the electrical data to optical data. The sending includes emitting light by the optical source. The emitted light is coupled to an optical medium. The optical medium can include a waveguide such as a waveguide fabricated by a nanoimprint lithography (NIL) process, an optical fiber, and so on. The light that is sent from the first circuit via the optical link is received by the second circuit. The receiving can be accomplished using a beam-dependent optical element (BDOE). The BDOE can include a photodiode.

The plurality of optical links includes a plurality of spare optical links. Each optical link in the plurality of optical links can include an optical source, an optical medium, and a beam-dependent optical element (BDOE). The optical source can include a VCSEL, a ring resonator, a light emitting diode, a laser diode, etc. The optical medium can include a waveguide, a fiberoptic cable, a multicore fiber cable, etc. One or more optical links within the plurality of optical links is tested. Recall that the first circuit sends data to the second circuit via a first optical link. The testing includes testing the first optical link. The testing can be accomplished by a processor, a testing processor, a controller, a core such as a controller core, and so on. The testing can be based on a round robin protocol, a pseudo-random binary sequence (PRBS) pattern, etc. The testing includes determining a failure within the first optical link. A controller replaces the failing optical link with a spare optical link. The spare optical link is within the plurality of optical links. Data is sent from the first circuit to the second circuit via the spare optical link.

Disclosed is a system for transmitting data comprising: a first circuit; a second circuit; a plurality of optical links, wherein the first circuit is coupled to the second circuit via a first optical link within the plurality of optical links, wherein the first circuit sends data to the second circuit based on the first optical link, and wherein the plurality of optical links includes a plurality of spare optical links; and a second optical link within the plurality of spare optical links; wherein the system is configured to: test the first optical link; determine a failure within the first optical link; and replace the first optical link with the second optical link.

The system 700 includes a first circuit 712. The first circuit can comprise a functional chip, chiplet, core, processor, memory, and so on. The system 700 includes a second circuit 714. The first circuit and the second circuit and be substantially the same or different. The first circuit and second circuit can be within a plurality of circuits bonded to a photonic wafer-scale interposer (PWSI). The system 700 includes a plurality of optical links 716, wherein the first circuit is coupled to the second circuit via a first optical link within the plurality of optical links, wherein the first circuit sends data to the second circuit based on the first optical link, and wherein the plurality of optical links includes a plurality of spare optical links. The optical links enable high-speed sending of data between the first circuit and the second circuit. The plurality of optical links can comprise hundreds, thousands, or more links. The system 700 includes a second optical link within the plurality of spare optical links, wherein the first optical link is replaced by the second optical link. The replacement of the first optical link by the second optical link can occur at any time. Any number of the plurality of optical links can be designated as spare optical links.

The optical links can be implemented in various ways. In some embodiments, the first optical link includes a first optical source and a first optical medium. The optical source can convert electrical data to optical data by emitting light that is based on the electrical data. In some embodiments, the first optical source includes a first vertical-cavity surface-emitting laser (VCSEL), within a plurality of VCSELs bonded to a photonic wafer-scale interposer (PWSI). A VCSEL can emit coherent light perpendicular to the surface of a chip. In some embodiments, the sending includes modulating a degree of freedom (DoF) of the first VCSEL, wherein the first VCSEL is coupled to the first circuit, wherein the modulating includes emitting, by the first VCSEL, a modulated light beam (MLB), wherein the MLB is based on the data that was sent from the first circuit. The DoF that is modulated can include an intensity, a polarization, a mode, a wavelength, etc. Modulating the DoF enables the encoding of data into the MLB. In other embodiments, the first optical source comprises a ring resonator. A ring resonator can selectively filter and emit light based on wavelength, a range of wavelengths, mode, polarization, and so on.

Various types of optical mediums can be used. In some embodiments, the first optical medium comprises a fiberoptic cable. A fiberoptic cable can enable the transmission of light based on total internal reflection of the fiberoptic cable. In other embodiments, the first optical medium comprises a multicore fiber cable. A multicore fiber cable can enable multiple light beams to be sent simultaneously. In other embodiments, the first optical medium comprises a first waveguide within a plurality of waveguides within the PWSI. A waveguide can enable the transmission of a beam of light by guiding the light beam along a path within a wafer, interposer, and so on. The waveguide can include a high containment region. In some embodiments, the first optical link includes a first beam-dependent optical element (BDOE), wherein the first BDOE is further coupled to the first waveguide. The BDOE can decode the MLB. Some embodiments include decoding, by the first BDOE, the MLB into the data that was sent. The decoding can include converting the data that was sent. The BDOE can convert the optical data to electrical data and deliver the optical data to the second circuit. Recall that data can be encoded into the MLB. In a usage example, one wavelength could be encoded as a logical “1”, and another wavelength as a logical “0” In this example, the BDOE can detect the different wavelengths and decode the MLB into the electrical data representing the data that was sent by the first circuit. The BDOE can deliver the data to the second circuit. In embodiments, the first BDOE includes a first photodiode, wherein the delivering is based on the first photodiode. A photodiode can convert light energy into an electrical current.

The system 700 includes a testing component 720. The testing component 720 is configured to test the first optical link. Various types of testing techniques can be used. The testing is based on a round robin protocol. A round robin protocol can allocate an equal amount of time to testing each optical link, ensuring that each optical link is tested within a designated window of time. The testing can be based on time domain reflectometry (TDR). In a usage example, the TDR can identify a break or other impedance change in an optical link. In some embodiments, the testing is based on a pseudo-random binary sequence (PRBS) pattern. A PRBS pattern can enable testing by using a random sequence of binary digits that is generated deterministically. The random sequence of digits can simulate real data streams and test the ability of the optical link to handle complex patterns. The deterministic generation can allow accurate identification of data that was sent incorrectly. The testing can be performed by a controller. The controller can be included on the PWSI, on a circuit such as a chiplet, and so on. The controller can be separate from the PWSI. In some embodiments, the testing includes substituting temporarily the first optical link with an additional optical link, wherein the additional optical link is within the plurality of spare optical links. When a link is in operation, it cannot be tested unless operation is paused, halted, stopped, etc. However, because a plurality of spare optical links is included within the PWSI, a spare optical link can be substituted for the first optical link. This allows the first optical link to be tested while operations continue to progress using the spare link. Note that the substituting temporarily can be a part of the round robin testing, such that operational links can be tested on a schedule. Note that there does not have to be suspicion that the first optical link is failing. The testing can occur transparent to the user. Some embodiments include switching the additional optical link with the first optical link, wherein the switching occurs after the first optical link is tested. Once the first optical link is tested and found to be operational, the additional optical link, which was a spare link, can be switched with the first optical link. Thus, the additional optical link can be used in the future as a spare link. This can allow for future testing of the additional optical link. Thus, disclosed embodiments provide a means for testing operational links in a way that is transparent to a user.

The system 700 includes a determining component 730. The determining component is configured to determine a failure within the first optical link. A component of the optical link can fail or degrade due to one or more of fabrication errors, degradation over time, physical failure (e.g., breakage), and so on. By identifying a failed or failing optical link, the problematic optical link can be switched out and replaced by a spare optical link. The determining can be based on sending data via the link and checking that the data was sent correctly. The determining can include an error rate. In a usage example, the error rate of an optical link can exceed a threshold. An error rate can be a percentage of data sent erroneously. The determining can include considering a link to have a failure if its error rate is above a threshold error rate. Other determining protocols, equations, standards, and so on can be used.

The system 700 includes a replacing component 740. The replacing component is configured to replace the first optical link with the second optical link. The replacing can be performed by a controller. The controller can be the same controller that performed the testing, or a different one. The replacing can be accomplished by “swapping out” or deselecting the failed optical link based on the determining. The replacing can enable the first circuit to send data to the second circuit via the second optical link. The replacing is transparent to the sending. Transparency can mean that the sending of data from the first circuit to the second circuit is not substantially disrupted by the replacing.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagram and flow diagram illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A method for transmitting data comprising:
coupling a first circuit within a plurality of circuits to a second circuit within the plurality of circuits, wherein the coupling is based on a first optical link within a plurality of optical links, wherein the plurality of optical links includes a plurality of spare optical links;
sending data, by the first circuit to the second circuit, wherein the sending is based on the first optical link;
testing the plurality of optical links, wherein the testing is based on a round robin protocol, wherein the testing includes determining a failure within the first optical link; and
replacing the first optical link with a second optical link, wherein the second optical link is within the plurality of spare optical links, and wherein the replacing is transparent to the sending.

2. The method of claim 1 wherein the first optical link includes a first optical source and a first optical medium.

3. The method of claim 2 wherein the first optical source comprises a ring resonator.

4. The method of claim 3 wherein the first optical medium comprises a fiberoptic cable.

5. The method of claim 3 wherein the first optical medium comprises a multicore fiber cable.

6. The method of claim 2 wherein the first optical source includes a first vertical-cavity surface-emitting laser (VCSEL) within a plurality of VCSELs bonded to a photonic wafer-scale interposer (PWSI).

7. The method of claim 6 wherein the plurality of circuits comprises a plurality of chiplets, wherein the plurality of chiplets is bonded to the PWSI.

8. The method of claim 6 wherein the PWSI comprises a directly modulated PWSI.

9. The method of claim 6 wherein the first optical medium comprises a first waveguide within a plurality of waveguides within the PWSI.

10. The method of claim 9 wherein the sending includes modulating a degree of freedom (DoF) of the first VCSEL, wherein the first VCSEL is coupled to the first circuit, wherein the modulating includes emitting, by the first VCSEL, a modulated light beam (MLB), wherein the MLB is based on the data that was sent from the first circuit.

11. The method of claim 10 wherein the degree of freedom comprises an intensity of the first VCSEL.

12. The method of claim 10 wherein the degree of freedom comprises a polarization of the first VCSEL.

13. The method of claim 10 wherein the degree of freedom comprises a mode of the first VCSEL.

14. The method of claim 10 wherein the degree of freedom comprises a wavelength of the first VCSEL.

15. The method of claim 10 further comprising coupling optically, by a first optical coupler, the MLB to the first waveguide.

16. The method of claim 15 wherein the first optical link includes a first beam-dependent optical element (BDOE), wherein the first BDOE is further coupled to the first waveguide.

17. The method of claim 16 further comprising decoding, by the first BDOE, the MLB into the data that was sent.

18. The method of claim 17 further comprising delivering the data to the second circuit.

19. The method of claim 18 wherein the first BDOE includes a first photodiode, wherein the delivering is based on the first photodiode.

20. The method of claim 9 wherein the second optical link comprises a second VCSEL within the plurality of VCSELs, wherein the second optical link comprises a second waveguide within the plurality of waveguides.

21. The method of claim 1 wherein the testing is based on a pseudo-random binary sequence (PRBS) pattern.

22. The method of claim 1 wherein the testing includes substituting temporarily the first optical link with an additional optical link, wherein the additional optical link is within the plurality of spare optical links.

23. The method of claim 22 further comprising switching the additional optical link with the first optical link, wherein the switching occurs after the first optical link is tested.

24. An apparatus for transmitting data comprising:
a first circuit;
a second circuit;
a plurality of optical links, wherein the first circuit is coupled to the second circuit via a first optical link within the plurality of optical links, wherein the first circuit sends data to the second circuit based on the first optical link, and wherein the plurality of optical links includes a plurality of spare optical links; and
a second optical link within the plurality of spare optical links, wherein the first optical link is replaced by the second optical link.

25. The apparatus of claim 24 wherein the first optical link includes a first optical source and a first optical medium.

26. The apparatus of claim 25 wherein the first optical source comprises a first vertical-cavity surface-emitting laser (VCSEL) within a plurality of VCSELs bonded to a photonic wafer-scale interposer (PWSI).

27. The apparatus of claim 26 wherein the first optical medium comprises a first waveguide within a plurality of waveguides within the PWSI.

28. The apparatus of claim 27 wherein the second optical link comprises a second VCSEL within the plurality of VCSELs, and wherein the second optical link comprises a second waveguide within the plurality of waveguides.

29. A system for transmitting data comprising:
a first circuit;
a second circuit;
a plurality of optical links, wherein the first circuit is coupled to the second circuit via a first optical link within the plurality of optical links, wherein the first circuit sends data to the second circuit based on the first optical link, and wherein the plurality of optical links includes a plurality of spare optical links; and
a second optical link within the plurality of spare optical links;
wherein the system is configured to:
test the first optical link;
determine a failure within the first optical link; and
replace the first optical link with the second optical link.
